(19) United States
(12) Patent Application Publication
(10) Pub. No.: US 2024/0313812 A1
(43) Pub. Date: Sep. 19, 2024

(54) SUBSAMPLING TRANSCEIVER CONFIGURATION WITH IMPROVED OUT-OF-BAND (OOB) REJECTION

(71) Applicant: QUALCOMM Incorporated, San Diego, CA (US)

(72) Inventors: Pranavsesh Vs, Hyderabad (IN); Balasubramanian Ramachandran, Hyderabad (IN); Abhishek Ananthrao Kulkarni, Gulbarga (IN)

(21) Appl. No.: 18/183,769

(22) Filed: Mar. 14, 2023

(51) Int. Cl. H04B 1/10; H04B 1/40

(52) U.S. Cl. CPC H04B 1/1027; H04B 1/40

(57) ABSTRACT

This disclosure provides systems, methods, and devices for wireless communications that support dodging out-of-band (OOB) jammers. In a first aspect, a apparatus for wireless communications, such as a wireless transceiver, includes a first radio frequency (RF) processing path for processing a first RF signal, the first RF processing path comprising a first analog-digital converter (ADC) configured to sample the first RF signal based on a first clock signal; and a second RF processing path for processing a second RF signal, the second RF signal being a spatially-diverse representation of the first RF signal, and the second RF processing path comprising a second analog-digital converter (ADC) configured to sample the second RF signal based on a second clock signal, wherein a first clock frequency of the first clock signal is different from a second clock frequency of the second clock signal. Other aspects and features are also claimed and described.

### TECHNICAL FIELD

Aspects of the present disclosure relate generally to wireless communication systems, and more particularly, to radio frequency (RF) processing circuitry for wireless communication systems. Some features may enable and provide improved communications, including improved operation of RF transceivers, such as subsampling transceivers.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, a radio frequency (RF) transceiver may include downconverters with different clock reference signals to cause the downconverters to sample an RF signal to dodge out-of-band jammers (OOB). Large amplitude jammers are undesired signals outside of the RF channel of interest that may interfere in the processing of the RF channel of interest. Two or more downconverters may be operated using clock signals at different frequencies to process RF signals present in an RF channel of interest that are received at different antennas. The downconverters convert the RF signals into baseband signals containing the information of the RF signal. The different frequencies for the two clock signals may be relatively close and may be related by a bandwidth of the carrier signal in the RF channel of interest. The two clock frequencies may be selected such that out-of-band jammers do not alias in a passband including the frequency of the carrier signal in the RF channel of interest. As a result, the out-of-band jammers are filtered out and do not interfere in downconverting the carrier signal in the RF channel of interest to baseband.

Two different clock frequencies may be applied to two different downconverters configured as part of a subsampling transceiver. In the subsampling transceivers, the RF signal is sampled using a frequency lower than twice the maximum input frequency for the carrier signal, but larger than two times the signal bandwidth of the carrier signal. One of the low-frequency replicas resulting from the sampling process, which contains the baseband signal, is then digitized to form information (e.g., control information or user data) that may be processed by a baseband modem. In some embodiments, the two different clock frequencies may be applied to two different downconverters configured to process two corresponding RF signals, such as two spatially-related RF signals received at two different, spatially-diverse antennas. The two antennas may be referred to as primary and diversity antennas of a wireless device (such as a user equipment (UE) or base station (BS)).

An example transceiver for wireless communication includes two converters with analog-to-digital converters (ADC) for subsampling RF signals from a primary and diversity RF signal received from a primary antenna and a diversity antenna, respectively. The ADCs may be operated with different clock signals, wherein the clock signals are selected such that out-of-band jammers do not alias in a passband including the frequency of the carrier signal. The different clock signals may be determined based on characteristics of the RF channel of interest, such as the center frequency and bandwidth, according to different techniques described in this disclosure.

An example method for wireless communication includes a controller determining a first and a second clock frequency such that out-of-band jammers do not alias in a passband including the frequency of the carrier signal. The controller configures a clock generator for generating a first and a second clock signal at the determined first and second frequency. The clock generator outputs the first and the second clock signals to first and second analog-to-digital converters (ADCs), respectively, to configure the ADCs for downconverting first and second RF signals, which may be received from spatially-diverse antennas of a user device. The wireless communication method further includes processing a baseband output of the two ADCs to obtain information for controlling the wireless communications of the user device and/or for providing data to the user (e.g., videos, pictures, messages, e-mails, attachments).

In one aspect of the disclosure, a user equipment or base station may include circuitry configured for wireless communications that includes a first radio frequency (RF) processing path for processing a first RF signal, the first RF processing path comprising a first analog-digital converter (ADC) configured to sample the first RF signal based on a first clock signal; and a second RF processing path for processing a second RF signal, the second RF signal being a spatially-diverse representation of the first RF signal, and the second RF processing path comprising a second analog-digital converter (ADC) configured to sample the second RF signal based on a second clock signal, wherein a first clock frequency of the first clock signal is different from a second clock frequency of the second clock signal.

In one aspect of the disclosure, a method for wireless communication includes determining a first clock frequency for sampling a first radio frequency (RF) signal and a second clock frequency for sampling a second RF signal that is a spatially-diverse representation of the first RF signal, wherein a first clock frequency of the first clock signal is different from a second clock frequency of the second clock signal; sampling the first RF signal for downconversion based on the first clock frequency to a first output signal; and sampling the second RF signal for downconversion based on the second clock frequency to a second output signal.

In an additional aspect of the disclosure, an apparatus includes at least one processor and a memory coupled to the at least one processor. The at least one processor is configured to determining a first clock frequency for sampling a first radio frequency (RF) signal and a second clock frequency for sampling a second RF signal that is a spatially-diverse representation of the first RF signal, wherein a first clock frequency of the first clock signal is different from a second clock frequency of the second clock signal; sampling the first RF signal for downconversion based on the first clock frequency to a first output signal; and sampling the second RF signal for downconversion based on the second clock frequency to a second output signal.

In an additional aspect of the disclosure, an apparatus includes means for determining a first clock frequency for sampling a first radio frequency (RF) signal and a second clock frequency for sampling a second RF signal that is a spatially-diverse representation of the first RF signal, wherein a first clock frequency of the first clock signal is different from a second clock frequency of the second clock signal; means for sampling the first RF signal for downconversion based on the first clock frequency to a first output signal; and means for sampling the second RF signal for downconversion based on the second clock frequency to a second output signal.

In an additional aspect of the disclosure, a non-transitory computer-readable medium stores instructions that, when executed by a processor, cause the processor to perform operations. The operations include determining a first clock frequency for sampling a first radio frequency (RF) signal and a second clock frequency for sampling a second RF signal that is a spatially-diverse representation of the first RF signal, wherein a first clock frequency of the first clock signal is different from a second clock frequency of the second clock signal; sampling the first RF signal for downconversion based on the first clock frequency to a first output signal; and sampling the second RF signal for downconversion based on the second clock frequency to a second output signal.

As used herein, a “radio frequency” signal is a signal having a frequency above baseband, which includes, in an example embodiment of a heterodyne receiver, intermediate frequency signals.

As used herein, an “intermediate frequency” signal is a RF signal that has been downconverted from another RF signal to a frequency that is above baseband, such as in an example embodiment of a heterodyne mm Wave transceiver that receives a mmWave RF signal and downconverts the mmWave RF signal to a mmWave IF signal that is further processed, such as through further downconversion, to a lower frequency RF signal or a baseband signal.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more embodiments of the disclosure.

FIG. 2 is a block diagram illustrating examples of a base station and a user equipment (UE) according to one or more embodiments of the disclosure.

FIG. 3 is a block diagram illustrating a frequency (RF) transceiver according to one or more embodiments of the disclosure.

FIG. 4 is a block diagram illustrating two ADCs operating at two frequencies selected such that out-of-band jammers do not alias in a passband including the frequency of the carrier signal according to one or more embodiments of the disclosure.

FIG. 5 are graphs illustrating aliasing zones based on two example frequencies for sampling RF signals according to one or more embodiments of the disclosure.

FIG. 6 is a table illustrating aliasing zones based on two example frequencies for sampling RF signals according to one or more embodiments of the disclosure.

FIG. 7 is a flow chart illustrating an example method for operating a subsampling RF transceiver according to one or more embodiments of the disclosure.

FIG. 8 is a block diagram of an example UE that supports transceivers with improved out of band jammer rejection in a wireless radio according to one or more aspects of the disclosure.

FIG. 9 is a block diagram of an example base station that supports improved out of band jammer rejection in a wireless radio according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support wireless communications, including techniques for dodging out-of-band (OOB) jammers by using two different clock frequencies for sampling spatially-diverse signals. The different clock frequencies, and correspondingly different ADC sampling frequencies, reduces the impact of OOB jammers on the downconverted baseband signal when the clock frequencies are chosen such that OOB jammers do not alias in a passband for the RF channel of interest.

Particular implementations of the subject matter described in this disclosure may be implemented to realize one or more of the following potential advantages or benefits. In some aspects, the present disclosure provides techniques for reducing SNR degradation because of OOB jammer aliasing. The benefits may be obtained through aspects of the disclosed techniques without adding any additional front-end RF filter components for rejecting OOB jammers. The reduced SNR degradation can improve user experience using the wireless communications device by improving data rates (e.g., by allowing increased channel widths or higher modulation and coding systems) and/or reducing data latency (e.g., by reducing the number of retransmissions of the same data).

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/see), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

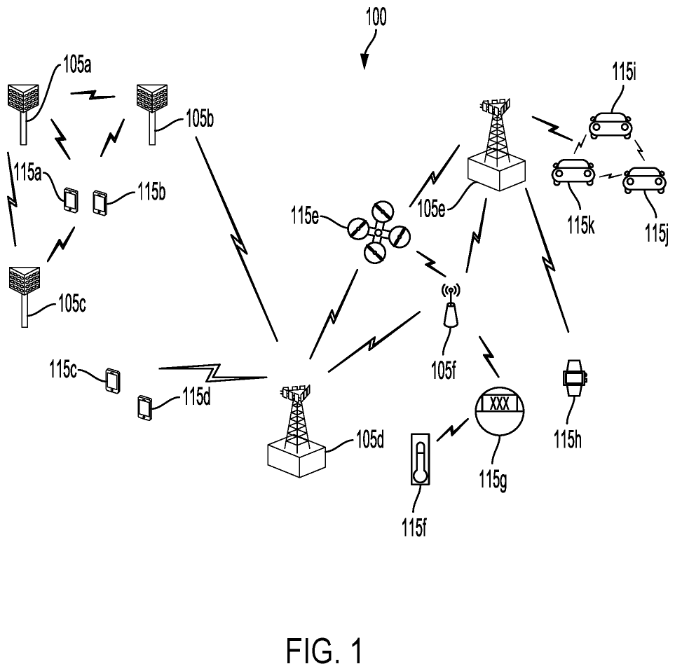

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, an aeronautical vehicle, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115c-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is an aeronautical vehicle. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

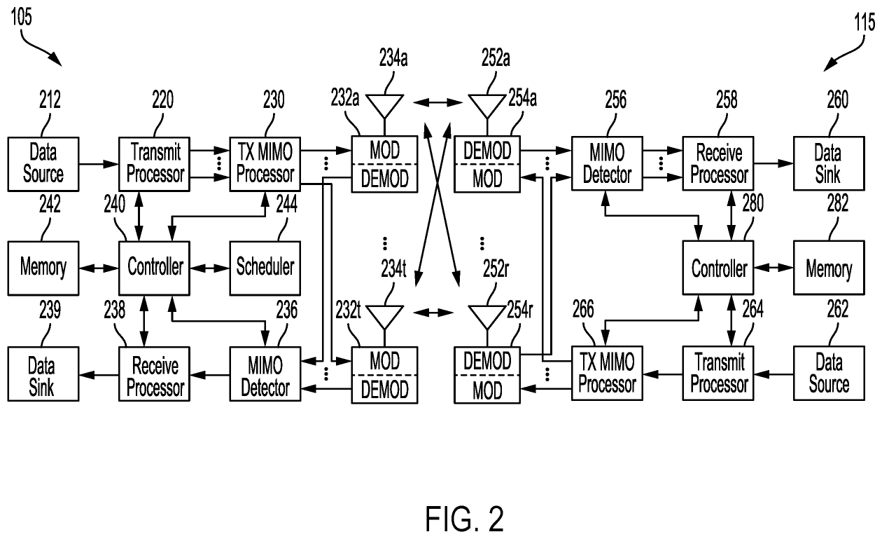

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

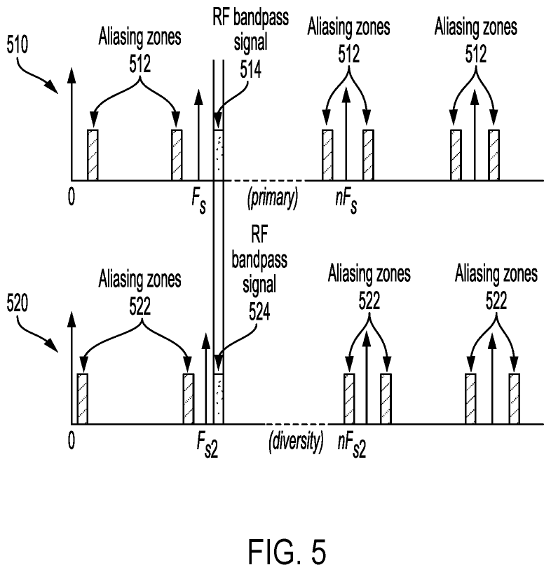

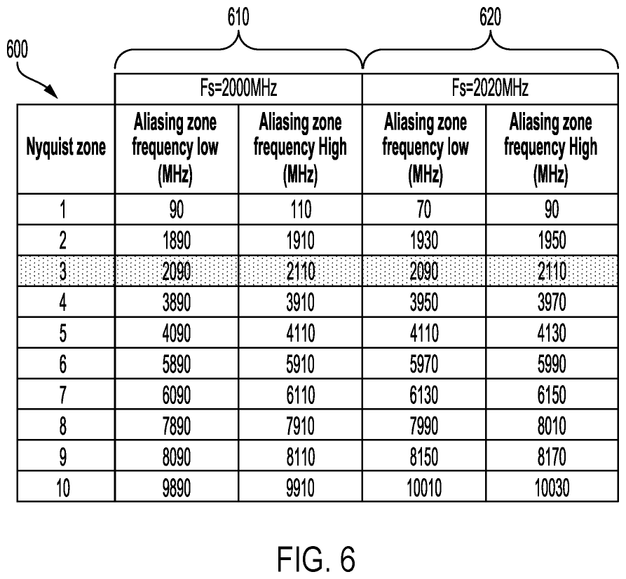

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 5 or FIG. 6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

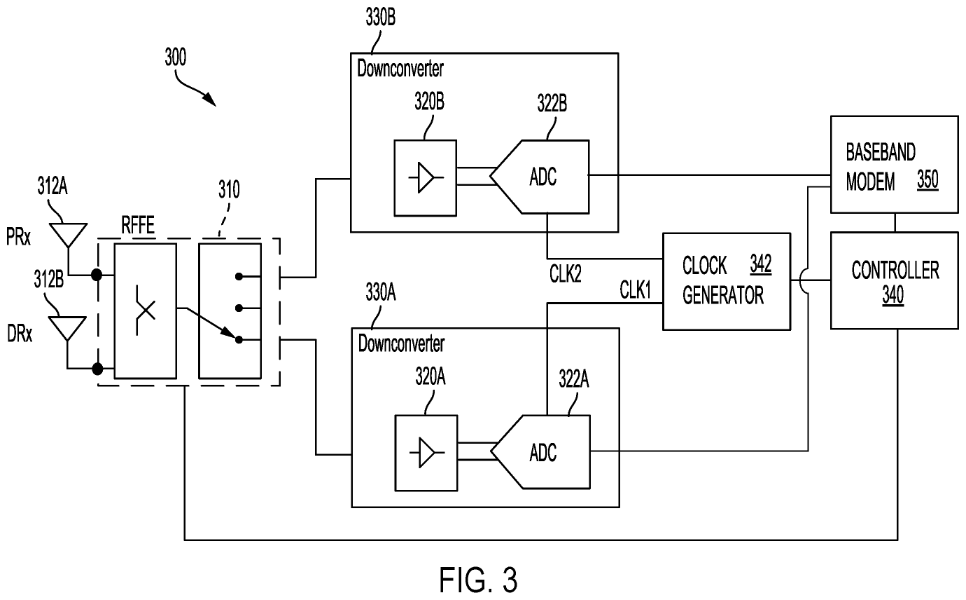

FIG. 3 is a block diagram illustrating a radio frequency (RF) receiver circuit 300 according to one or more embodiments of the disclosure. In some embodiments, the receiver circuit 300 may be part of a converged sub-6 Ghz and mmWave radio frequency (RF) transceiver, a sub-6 GHz radio frequency (RF) transceiver, a mmWave radio frequency (RF) transceiver, or a RF transceiver for another wireless communication system. In some embodiments, portions or all of the RF transceiver of FIG. 3 may be located in a single integrated circuit (IC) sharing a common substrate. For example, downconverters 330A-B, clock generator 342, baseband modem 350, and/or controller 340 may be construed as a RF transceiver on a common silicon substrate. Although the receiver circuit 300 is described in terms of receiving signals and processing received signals, the circuit 300 may also be configured for generating signals and transmitting signals through the same antennas 312A-B.

The receiver circuit 300 may include antennas 312A-B that receive radio frequency (RF) signals. In some embodiments, the antennas 312A-B may each include multiple antennas, such as when antennas 312A-B are phase antenna arrays. The antennas 312A-B may be spatially-diverse antennas for receiving correlated RF signals. In a wireless system employing spatial diversity for improved communications, the antenna 312A may be a primary antenna and the antenna 312B may be a diversity antennas. Each of the antennas 312A and 312B may be located at different locations and/or with different orientations on a wireless device.

The antennas 312A-B are coupled to a RF front-end (RFFE) 310 through first and second antenna input ports, respectively. The RFFE 310 may include duplexers, SAW filters, switches, external LNAs, and/or other transmit or receive circuits for conditioning signals received from or transmitted to the antennas 312A-B. In some embodiments, the RFFE 310 may include separate circuits for conditioning or otherwise processing sub-6 GHZ signals, mmWave signals, satellite signals, and/or other signals. For example, the RFFE 310 may include a first plurality of circuits for conditioning a sub-6 GHz signal for further processing by other circuitry and a second plurality of circuits for conditioning a mmWave RF signal for further processing by other circuitry. The output of the RFFE 310 in this example may be two RF signals for input to other circuitry, wherein the two RF signals include conditioned sub-6 GHZ signals and/or conditioned mmWave IF signals.

The RFFE 310 may output the conditioned RF signals as input RF signals to downconverters 330A-B, which may include internal amplifiers 320A-B, such as a low noise amplifiers (LNAs). The downconverters 330A-B may include additional circuitry for processing the RF signal by downconverting the output of amplifiers 320A-B to lower frequency signals, such as an intermediate frequency (IF) signal or baseband (BB) signal. One example configuration for a downconverter is a subsampling downconverter, in which the RF signal (as output form amplifiers 320A-B) is sampled using a frequency lower than twice the maximum input frequency, but larger than two times the signal bandwidth.

One implementation of a subsampling receiver includes analog-to-digital converters (ADCs) 322A-B for sampling the RF signals. The ADCs 322A-B may sample the RF signals based on clock signals CLK1 and CLK2, respectively. The subsampling produces a baseband signal comprising a plurality of replicas. One of the low-frequency replicas resulting from the sampling process, which contains the baseband signal, may be digitized to obtain the information in the RF channel of interest. Other implementations of the downconverters 330A-B may include mixers, baseband filters (BBFs), and/or analog-to-digital converters (ADCs). Although internal LNA amplifiers 320A-B are shown in downconverters 330A-B, the downconverters 330A-B may omit internal LNAs. In some embodiments, one internal amplifier may be shared by ADCs 322A-B, such as by using a split LNA amplifier.

Out-of-band (OOB) jammers may be strong signals (e.g., >50% of the signal-to-noise ratio (SNR) of the RF channel of interest in the received signal). Without sufficient rejection, an OOB jammer present may be aliased into the in-band portion of the received signal and cause significant SNR degradation of the received signal. Out-of-band jammers may be reduced or eliminated by selecting the clock frequency supplied to each of the ADCs 322A-B to obtain ADC sampling rates resulting in two different sets of aliasing regions for the RF signals received at antennas 312A-B.

Selecting appropriate frequencies for the aliasing regions of the primary and diversity receive paths in receiver circuit 300 to obtain aliasing regions that are non-overlapping between the primary and diversity paths allow dodging the OOB jammer present at any arbitrary offset in one of the RF signal processing paths. During maximal ration combining (MRC) in baseband modem 350, weighting may be applied to the baseband signal outputs of downconverters 330A-B to prioritize the receiver path with higher SNR. The path that dodges the OOB jammer will thus have higher weighting and SNR degradation resulting from the OOB jammer is reduced.

Each of the signal paths through the receiver circuit 300 may be referred to as a RF processing path that is processed through an RF processing chain of components. For example, a primary signal processing path may proceed from antenna 312A to RFFE 310, to downconverter 330A, and to baseband modem 350, with the RFFE 310 and downconverter 330A being a first RF processing chain. As another example, a diversity signal processing path may proceed from antenna 312B to RFFE 310, to downconverter 330B, and to baseband modem 350, with the RFFE 310 and downconverter 330B being a second RF processing chain.

A controller 340 may detect conditions in the RF signal received from the antennas 312A-B, such as through feedback from the RFFE 310, or receive information regarding the carrier configuration from higher levels, such as a MAC layer or network layer, received as feedback from baseband modem 350. The controller 340 may configure components of the receiver circuit 300 to activate, deactivate, or control portions of the receiver circuit 300 to process an input RF signal based on the feedback. In some embodiments, the controller 340 configures components to reduce OOB jammer interference within the receiver circuit 300. For example, the controller 340 may configure a clock generator 342 with selected first and second clock frequencies for operating ADCs 322A-B such that the second clock frequency is chosen such that OOB jammers do not alias in a passband. The clock generator 342 may receive a reference clock signal that is manipulated, such as through clock divider circuits, to obtain a first clock CLK1 and a second clock CLK2 for operating ADCs 322A-B. The clock generator 342 may alternatively or also include a reference clock generator, such as a voltage-controlled oscillator (VCO) that is input to a clock divider to obtain the CLK1 and CLK2 signals. In some embodiments, the clock generator 342 may include two reference clock generators for generating the CLK1 and CLK2 signals.

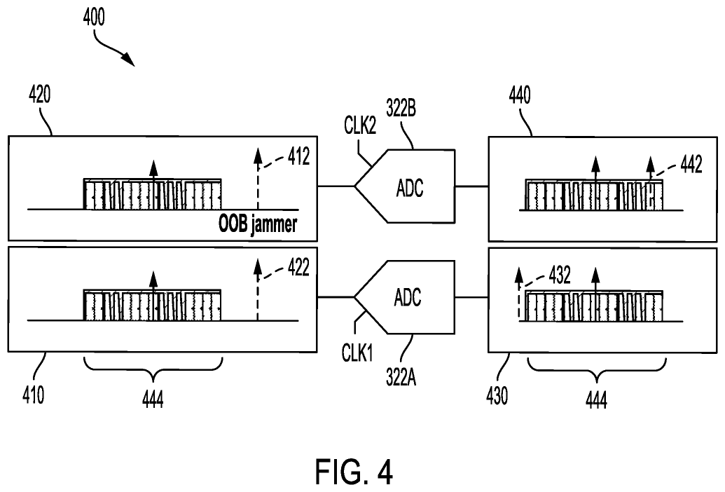

FIG. 4 is a block diagram illustrating two ADCs operating at two frequencies selected such that out-of-band jammers do not alias in a passband including the frequency of the carrier signal according to one or more embodiments of the disclosure. System 400 illustrates RF signal 410 and RF signal 420 processed through ADCs 322A and 322B, respectively. The RF signals 410 and 420 are similar because they are spatially-diverse representations of an RF signal transmitted to the wireless device. Each RF signal 410, 420 include an out of band (OOB) jammer 412, 422 outside of an RF channel of interest, which may be downlink channel 444. The downlink channel 444 includes information carried on a carrier signal. The ADCs 332A and 322B are operated to sample the RF signals 410 and 420, respectively, based on clock signals at different frequencies, which may be selected according to criteria described in this disclosure to reduce interference from the OOB jammers 412 and 422. The resulting subsampled baseband signals 430 and 440 from RF signals 410 and 420, respectively, include the downlink channel information in passband 444. In the baseband signal 440, an alias 442 of the OOB jammer 412 appears in the passband 444, and may interfere with decoding of the information in the downlink channel. In the baseband signal 430, an alias 432 of the OOB jammer 422 appears outside of the passband 444. A baseband modem processing the baseband signals 430 and 440 may select baseband signal 440 for processing or may overweight baseband signal 440 when combining with baseband signal 430. The clock frequencies input to ADCs 322A-B are selected to dodge the OOB jammer from aliasing by selecting frequencies such that the aliasing zones for RF signals 410 and 420 are non-overlapping. Thus, the OOB jammer at a given offset will always alias only in one of the baseband outputs 430 and 440, as shown in the example of FIG. 4.

An illustration of selecting sampling frequencies for the ADCs resulting in different aliasing zones outside of a passband is shown in FIG. 5. FIG. 5 are graphs illustrating aliasing zones based on two example frequencies for sampling RF signals according to one or more embodiments of the disclosure. An RF sub-sampling ADC with a sampling frequency of Fₛ (which may be the clock frequency CLK1 described with respect to FIG. 3 or otherwise is based on CLK1) generates harmonics at Fₛ, 2Fₛ, . . . nFₛ, wherein n is an integer. The closest harmonic to bandpass RF signal is k, k=floor(F_{c}/Fₛ), wherein F_{c} represents a center frequency of a downlink channel, such as a carrier frequency. An aliasing region may exist in every Nyquist zone, each of which folds back on top of the downlink signal after the sub-sampling. Those aliasing zones can be determined from:

−nFₛ+F_{c}, and

(n+1)Fₛ−F_{c}.

wherein n is an integer. The difference in sampling frequency Fₛ between primary and diversity paths depends on the bandwidth (BW) of the downlink signal. The sampling frequency may be selected such that

$${F}_{diversity} = {F}_{primary} \pm BW ,$$

which results in the aliasing zones of the primary and diversity paths being completely non-overlapping.

In FIG. 5, the graph 510 illustrates aliasing zones on the primary signal when sampled at a first sampling frequency Fₛ, and the graph 520 illustrates aliasing zones on the diversity signal when sampled at a second sample frequency Fₛ₂. As shown, aliasing zones 512 of the primary path do not overlap with the aliasing zones 522 of the diversity path, except at one overlapping zone containing the RF bandpass signal 514 in the primary signal and RF bandpass signal 524 in the diversity signal.

In one example operation for receiving a downlink signal centered at 2100 MHz with a bandwidth (BW) of 20 MHz, the ADCs may be configured with a sampling frequency on the primary path of F_{primary}=2000 MHz and a sampling frequency on the diversity path of F_{diveristy}=F_{primary}±BW, which is 2020 MHz or 1980 MHz. Example Nyquist zones for sampling frequencies of 2000 MHz and 2020 MHz are shown in FIG. 6. FIG. 6 is a table illustrating aliasing zones based on two example frequencies for sampling RF signals according to one or more embodiments of the disclosure. The aliasing zones 610 of the primary path and the aliasing zones 620 of the diversity path are non-overlapping except in one Nyquist zone (e.g., Nyquist zone 3 in table 600 of FIG. 6), which protects one of the receive paths (e.g., primary or diversity path) from aliasing of an OOB jammer at an arbitrary offset to the downlink signal.

In some embodiments, a maximum offset in sampling frequency between primary and diversity paths can be reduced if a SAW filter in the receive path has sufficient rejection in the first Nyquist zone, such that no OOB jammers may be aliased into the first Nyquist zone. In such a configuration, the frequency offset between sampling frequencies for the primary and diversity paths may be determined by the downlink signal bandwidth and the lowest Nyquist zone for dodging OOB jammers. The frequency for the diversity path sampling frequency and the primary path sampling frequency may be represented by:

$${F}_{diversity} = {F}_{primary} \pm BW / n ,$$

wherein n is the lowest Nyquist zone for dodging the OOB jammer. If the offset is decided based on n^{th} Nyquist zone, then dodging may be applicable to all the Nyquist zones greater than or equal to n.

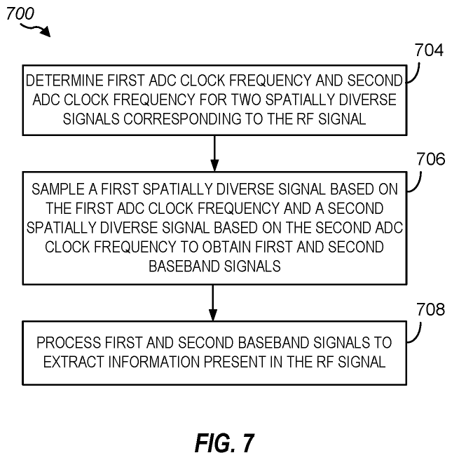

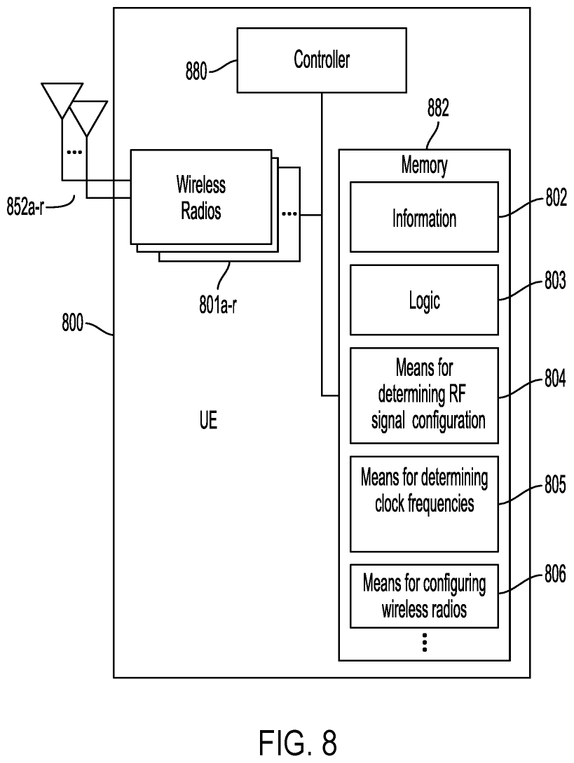

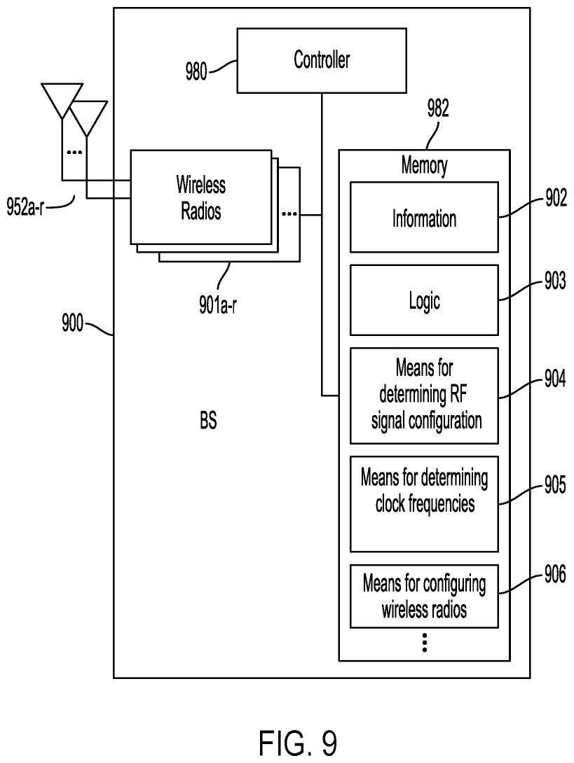

FIG. 7 is a flow chart illustrating an example method for operating a subsampling RF transceiver according to one or more embodiments of the disclosure. A method 700 for wireless communication, such as by a UE illustrated in FIG. 8 or a BS illustrated in FIG. 9, begins, at block 704, with the device determining a first ADC clock frequency and a second ADC clock frequency for sampling two spatially-diverse signals corresponding to the communications channel of interest (which may be an assigned carrier signal with a carrier frequency). The two ADC clock frequencies may be determined according to the example equations described herein. The clock frequencies may be chosen such that the first clock frequency and second clock frequency result in one overlapping aliasing zone around a center frequency of a communications signal in the RF signal with other aliasing zones non-overlapping. In some embodiments, the second clock frequency is different from the first clock frequency by an offset value proportional to a bandwidth of a communications signal in the first RF signal. In some embodiments, the first clock frequency corresponds to a center frequency of the communications signal. The first and second clock frequencies may be determined based on signal information, which may include the center frequency and bandwidth, for a channel of interest, such as a downlink grant or other resource assignment that specifies an active carrier for the wireless device.

At block 706, the subsampling receiver operates using the first and second ADC clock frequencies to sample a first RF signal based on the first ADC clock frequency and a second RF signal (spatially-diverse to the first RF signal) based on the second ADC clock frequency to obtain first and second baseband signals.

At block 708, the first and second baseband signals are processed to extract information present in the RF signal. For example, a baseband modem may decode the one of the first and second baseband signals with the highest SNR. As another example, a baseband modem may decode both of the first and second baseband signals and combine by overweighting the baseband signal with a higher SNR and underweighting the baseband signal with a lower SNR.

Wireless receiver operation to dodge OOB jammers from aliasing into the passband may be obtained by using different ADC rates for primary and diversity paths such that the aliasing zones of primary and diversity paths are non-overlapping, such that one of the signal paths is protected from aliasing of the OOB jammer at an arbitrary offset. Thus, SNR degradation because of OOB jammer aliasing can be avoided, and may be obtained through these techniques without adding any additional front-end RF filter components for rejecting OOB jammers.

Operations of method 700 may be performed by a UE, such as UE 115 described above with reference to FIG. 1 or FIG. 2, or a UE described with reference to FIG. 8. For example, example operations (also referred to as “blocks”) of method 700 may enable UE 115 to support improved OOB rejection.

FIG. 8 is a block diagram of an example UE 800 that supports reconfiguring a downconverter of a wireless radio according to one or more aspects of the disclosure. UE 800 may be configured to perform operations, including the blocks of a process described with reference to the above methods. In some implementations, UE 800 includes the structure, hardware, and components shown and described with reference to UE 115 of FIG. 1 or FIG. 2. For example, UE 800 includes controller 880, which operates to execute logic or computer instructions stored in memory 882, as well as controlling the components of UE 800 that provide the features and functionality of UE 800. UE 800, under control of controller 880, transmits and receives signals via wireless radios 801a-r and antennas 852a-r. Wireless radios 801a-r include various components and hardware, as illustrated in FIG. 2 for UE 115, including modulator and demodulators 254a-r, MIMO detector 256, receive processor 258, transmit processor 264, and TX MIMO processor 266. Wireless radios 801a-r may also include one or more receiver circuits with downconverters configured as shown in FIG. 3.

As shown, memory 882 may include information 802, logic 803, means for determining RF signal configuration 804, means for determining clock frequencies 805, and/or means for configuring wireless radios 806. Information 802 may be configured to include, for example, active frequencies, resource assignments, and/or carrier signals. Logic 803 may be configured to process the information 802, update the information 802, generate new configuration data for information 802, and/or store information regarding the current operating mode, e.g., assigned DL grants and/or BWPs. Means for determining RF signal configuration 804 may be configured to receive information from the wireless radios 801a-r, from the controller 880, and/or from information 802 to determine active frequencies in a RF signal received by the UE 800. Means for determining clock frequencies 705 may be configured to determine first and second clock frequencies based on the determined wireless radio configuration from block 804. For example, block 805 may obtain appropriate information from a lookup table stored in information 802 using the configuration determined by block 805 as an index into the look-up table. Means for configuring wireless radios 806 may use the values determined by block 705 to change the configuration of one or more of the wireless radios 801a-r, such as through the controller 880 controlling a clock generator to obtain first and second clock frequencies. In some embodiments, some of the wireless radios 801a-r may be configured for mmWave operation and other of the wireless radios 801a-r may be configured for sub-6 GHz operation. UE 800 may receive signals from or transmit signals to one or more network entities, such as base station 105 of FIG. 1 or FIG. 2 or a base station as illustrated in FIG. 9.

FIG. 9 is a block diagram of an example base station 900 that supports reconfiguring a downconverter of a wireless radio according to one or more aspects of the disclosure. Base station 900 may be configured to perform operations, including the blocks of method 700 described with reference to FIG. 7. In some implementations, base station 900 includes the structure, hardware, and components shown and described with reference to base station 105 of FIG. 1 or FIG. 2. For example, base station 900 may include controller 240, which operates to execute logic or computer instructions stored in memory 242, as well as controlling the components of base station 900 that provide the features and functionality of base station 900. Base station 900, under control of controller 240, transmits and receives signals via wireless radios 901a-t and antennas 934a-t. Wireless radios 901a-t include various components and hardware, as illustrated in FIG. 2 for base station 105, including modulator and demodulators 232a-t, transmit processor 220, TX MIMO processor 230, MIMO detector 236, and receive processor 238. Wireless radios 901a-r may also include one or more receiver circuits with downconverters configured as shown in FIG. 3.

As shown, memory 982 may include information 902, logic 903, means for determining carrier aggregation configuration 904, means for determining clock frequencies 905, and/or means for configuring wireless radios 906. Information 902 may be configured to include, for example, active frequencies, resource assignments, carrier signals, and/or environmental characteristics. Logic 903 may be configured to process the information 902, update the information 902, generate new configuration data for information 902, and/or store information regarding the current operating mode, e.g., assigned DL grants and/or BWPs. Means for determining RF signal configuration 904 may be configured to receive information from the wireless radios 901a-r, from the controller 980, and/or from information 902 to determine active frequencies for the BS 900. Means for configuring wireless radios 906 may use clock frequencies determined by means for determining clock frequencies 905 to change the configuration of one or more of the wireless radios 901a-r, such as through the controller 980. In some embodiments, some of the wireless radios 901a-r may be configured for mm Wave operation and other of the wireless radios 801a-r may be configured for sub-6 GHz operation. Base station 900 may receive signals from or transmit signals to one or more UEs, such as UE 115 of FIG. 1 or FIG. 2 or UE 800 of FIG. 8.

In one or more aspects, techniques for supporting wireless communications, such as on multiple frequency bands, may include additional aspects, such as any single aspect or any combination of aspects described below or in connection with one or more other processes or devices described elsewhere herein. In a first aspect, supporting wireless communication may include an apparatus with a subsampling receiver in which different spatially diverse paths are sampled at different sampling frequencies. Additionally, the apparatus may perform or operate according to one or more aspects as described below. In some implementations, the apparatus includes a wireless device, such as a UE or a base station (BS). In some implementations, the apparatus may include at least one processor, and a memory coupled to the processor. The processor may be configured to perform operations described herein with respect to the apparatus, including operations described herein with respect to methods of operating a wireless device. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a first aspect, supporting wireless communication may include an apparatus including a first radio frequency (RF) processing path for processing a first RF signal, the first RF processing path comprising a first analog-digital converter (ADC) configured to sample the first RF signal based on a first clock signal; and a second RF processing path for processing a second RF signal, the second RF signal being a spatially-diverse representation of the first RF signal, and the second RF processing path comprising a second analog-digital converter (ADC) configured to sample the second RF signal based on a second clock signal, wherein a first clock frequency of the first clock signal is different from a second clock frequency of the second clock signal.

In a second aspect, in combination with the first aspect, the second clock frequency is different from the first clock frequency by an offset value proportional to a bandwidth of a communications signal in the first RF signal.

In a third aspect, in combination with one or more of the first aspect or the second aspect, the first clock frequency corresponds to a center frequency of the communications signal.

In a fourth aspect, in combination with one or more of the first aspect through the third aspect, the first clock frequency and the second clock frequency result in one overlapping aliasing zone including a center frequency of a communications signal in the first RF signal.

In a fifth aspect, in combination with one or more of the first aspect through the fourth aspect, the apparatus may also include a clock generator coupled to the first ADC and coupled to the second ADC, the clock generator configured to output the first clock signal and the second clock signal.

In a sixth aspect, in combination with one or more of the first aspect through the fifth aspect, the apparatus may also include a controller coupled to the clock generator, wherein the controller is configured to perform operations comprising: receiving signal information regarding a channel of interest for processing by the first RF processing path and the second RF processing path; and determining the first clock frequency and the second clock frequency based on the signal information.

In a seventh aspect, in combination with one or more of the first aspect through the sixth aspect, the signal information comprises a center frequency of the channel of interest, and wherein the first clock frequency and the second clock frequency are each based on the center frequency.

In an eighth aspect, in combination with one or more of the first aspect through the seventh aspect, the signal information comprises a bandwidth of the channel of interest, wherein the second clock frequency is determined as an offset from the first clock frequency, and wherein the offset is based on the bandwidth.

In a ninth aspect, in combination with one or more of the first aspect through the eighth aspect, the signal information comprises the center frequency and the bandwidth received as part of a resource assignment received by the apparatus.

In a tenth aspect, in combination with one or more of the first aspect through the ninth aspect, the first RF processing path is configured to couple to a first antenna through a first input port, and the second RF processing path is configured to couple to a second antenna through a second input port, wherein the first antenna comprises a primary antenna and the second antenna comprises a diversity antenna.

In an eleventh aspect, in combination with one or more of the first aspect through the tenth aspect, a method of wireless communication may include steps comprising the operations of determining a first clock frequency for sampling a first radio frequency (RF) signal and a second clock frequency for sampling a second RF signal that is a spatially-diverse representation of the first RF signal, wherein a first clock frequency of the first clock signal is different from a second clock frequency of the second clock signal; sampling the first RF signal for downconversion based on the first clock frequency to a first output signal; and sampling the second RF signal for downconversion based on the second clock frequency to a second output signal.

In a twelfth aspect, in combination with one or more of the first aspect through the eleventh aspect, the first output signal comprises a first baseband signal and the second output signal comprises a second baseband signal, with the method further comprising determining information in a channel of interest in the first RF signal based on the first baseband signal and the second baseband signal.

In a thirteenth aspect, in combination with one or more of the first aspect through the twelfth aspect, the second clock frequency is different from the first clock frequency by an offset value proportional to a bandwidth of a communications signal in the first RF signal.

In a fourteenth aspect, in combination with one or more of the first aspect through the thirteenth aspect, the first clock frequency corresponds to a center frequency of the communications signal.

In a fifteenth aspect, in combination with one or more of the first aspect through the fourteenth aspect, determining the first clock frequency comprises determining the first clock frequency such that first aliasing zones corresponding to the first clock frequency are non-overlapping second aliasing zones corresponding to the second clock frequency except in one overlapping aliasing zone that includes a center frequency of a communications signal in the first RF signal.

In a sixteenth aspect, in combination with one or more of the first aspect through the fifteenth aspect, the method further includes receiving a resource assignment for communications on a channel of interest, wherein the determining the first clock frequency and the determining the second clock frequency is based on the resource assignment.

In as seventeenth aspect, in combination with one or more of the first aspect through the sixteenth aspect, the first clock frequency is a center frequency of a channel of interest, and wherein the second clock frequency is determined as a sum or difference of the first clock frequency with a result of dividing a bandwidth of the channel of interest by an integer corresponding to a Nyquist zone.

In an eighteenth aspect, in combination with one or more of the first aspect through the seventeenth aspect, sampling the first RF signal for downconversion comprises sampling a RF signal received from a primary antenna, and wherein sampling the second RF signal for downconversion comprises sampling a RF signal received from a diversity antenna.

In a nineteenth aspect, in combination with one or more of the first aspect through the eighteenth aspect, an apparatus includes a memory storing processor-readable code, and at least one processor coupled to the memory, the at least one processor configured to execute the processor-readable code to cause the at least one processor to perform operations including determining a first clock frequency for sampling a first radio frequency (RF) signal and a second clock frequency for sampling a second RF signal that is a spatially-diverse representation of the first RF signal, wherein the first clock frequency is different from the second clock frequency; sampling the first RF signal for downconversion based on the first clock frequency to a first output signal; and sampling the second RF signal for downconversion based on the second clock frequency to a second output signal.

In a twentieth aspect, in combination with one or more of the first aspect through the nineteenth aspect, the first output signal comprises a first baseband signal and the second output signal comprises a second baseband signal, the operations further comprising determining information in a channel of interest in the first RF signal based on the first baseband signal and the second baseband signal.

In a twenty-first aspect, in combination with one or more of the first aspect through the twentieth aspect, the second clock frequency is different from the first clock frequency by an offset value proportional to a bandwidth of a communications signal in the first RF signal.

In a twenty-second aspect, in combination with one or more of the first aspect through the twenty-first aspect, the first clock frequency corresponds to a center frequency of the communications signal.

In a twenty-third aspect, in combination with one or more of the first aspect through the twenty-second aspect, the apparatus further includes a first RF processing path coupled to the at least one processor, the first RF processing path comprising a first analog-digital converter (ADC) configured to sample the first RF signal based on a first clock signal having the first clock frequency; and a second RF processing path coupled to the at least one processor, the second RF processing path comprising a second analog-digital converter (ADC) configured to sample the second RF signal based on a second clock signal having the second clock frequency.

In a twenty-fourth aspect, in combination with one or more of the first aspect through the twenty-third aspect, the apparatus further includes a first antenna port configured to couple the first RF processing path to a primary antenna; and a second antenna port configured to couple the second RF processing path to a diversity antenna.

In a twenty-fifth aspect, in combination with one or more of the first aspect through the twenty-fourth aspect, the first clock frequency is a center frequency of a channel of interest, and wherein the second clock frequency is determined as a sum or difference of the first clock frequency with a result of dividing a bandwidth of the channel of interest by an integer corresponding to a Nyquist zone.

In a twenty-sixth aspect, in combination with one or more of the first aspect through the twenty-fifth aspect, an apparatus for performing one or more of the operations described herein may include means for determining a first clock frequency for sampling a first radio frequency (RF) signal and a second clock frequency for sampling a second RF signal that is a spatially-diverse representation of the first RF signal, wherein a first clock frequency of the first clock signal is different from a second clock frequency of the second clock signal; means for sampling the first RF signal for downconversion based on the first clock frequency to a first output signal; and/or means for sampling the second RF signal for downconversion based on the second clock frequency to a second output signal.

In a twenty-seventh aspect, in combination with one or more of the first aspect through the twenty-fifth aspect, the first output signal comprises a first baseband signal and the second output signal comprises a second baseband signal, the apparatus further comprising means for determining information in a channel of interest in the first RF signal based on the first baseband signal and the second baseband signal.

In a twenty-eighth aspect, in combination with one or more of the first aspect through the twenty-seventh aspect, the second clock frequency is different from the first clock frequency by an offset value proportional to a bandwidth of a communications signal in the first RF signal.

In a twenty-nineth aspect, in combination with one or more of the first aspect through the twenty-eighth aspect, the first clock frequency corresponds to a center frequency of the communications signal.

In a thirtieth aspect, in combination with one or more of the first aspect through the twenty-nineth aspect, the first clock frequency and the second clock frequency result in one overlapping aliasing zone that includes a center frequency of a communications signal in the first RF signal.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-9 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 3 and 4 may be combined with one or more blocks (or operations) described with reference to another of the figures. For example, one or more blocks (or operations) of FIG. 3 may be combined with one or more blocks (or operations) of FIG. 1. As another example, one or more blocks associated with FIG. 4 may be combined with one or more blocks (or operations) associated with FIG. 1. Additionally, or alternatively, one or more operations described above with reference to FIGS. 1-4 may be combined with one or more operations described with reference to FIGS. 5-9.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus, comprising:
a first radio frequency (RF) processing path for processing a first RF signal, the first RF processing path comprising a first analog-digital converter (ADC) configured to sample the first RF signal based on a first clock signal; and
a second RF processing path for processing a second RF signal, the second RF signal being a spatially-diverse representation of the first RF signal, and the second RF processing path comprising a second analog-digital converter (ADC) configured to sample the second RF signal based on a second clock signal,
wherein a first clock frequency of the first clock signal is different from a second clock frequency of the second clock signal.

2. The apparatus of claim 1, wherein the second clock frequency is different from the first clock frequency by an offset value proportional to a bandwidth of a communications signal in the first RF signal.

3. The apparatus of claim 2, wherein the first clock frequency corresponds to a center frequency of the communications signal.

4. The apparatus of claim 1, wherein the first clock frequency is a frequency such that first aliasing zones corresponding to the first clock frequency are non-overlapping second aliasing zones corresponding to the second clock frequency except in one overlapping aliasing zone including a center frequency of a communications signal in the first RF signal.

5. The apparatus of claim 1, further comprising:
a clock generator coupled to the first ADC and coupled to the second ADC, the clock generator configured to output the first clock signal and the second clock signal.

6. The apparatus of claim 5, further comprising:
a controller coupled to the clock generator, wherein the controller is configured to perform operations comprising:
receiving signal information regarding a channel of interest for processing by the first RF processing path and the second RF processing path; and
determining the first clock frequency and the second clock frequency based on the signal information.

7. The apparatus of claim 6, wherein the signal information comprises a center frequency of the channel of interest, and wherein the first clock frequency and the second clock frequency are each based on the center frequency.

8. The apparatus of claim 7, wherein the signal information comprises a bandwidth of the channel of interest, wherein the second clock frequency is determined as an offset from the first clock frequency, and wherein the offset is based on the bandwidth.

9. The apparatus of claim 8, wherein the signal information comprises the center frequency and the bandwidth received as part of a resource assignment received by the apparatus.

10. The apparatus of claim 1, wherein the first RF processing path is configured to couple to a first antenna through a first input port, and the second RF processing path is configured to couple to a second antenna through a second input port, wherein the first antenna comprises a primary antenna and the second antenna comprises a diversity antenna.

11. A method, comprising:
determining a first clock frequency for sampling a first radio frequency (RF) signal and a second clock frequency for sampling a second RF signal that is a spatially-diverse representation of the first RF signal, wherein the first clock frequency is different from the second clock frequency;
sampling, based on the first clock frequency, the first RF signal for downconversion to a first output signal; and
sampling, based on the second clock frequency, the second RF signal for downconversion to a second output signal.

12. The method of claim 11, wherein the first output signal comprises a first baseband signal and the second output signal comprises a second baseband signal, the method further comprising determining information in a channel of interest in the first RF signal based on the first baseband signal and the second baseband signal.

13. The method of claim 11, wherein the second clock frequency is different from the first clock frequency by an offset value proportional to a bandwidth of a communications signal in the first RF signal.

14. The method of claim 13, wherein the first clock frequency corresponds to a center frequency of the communications signal.

15. The method of claim 11, wherein determining the first clock frequency comprises determining the first clock frequency such that first aliasing zones corresponding to the first clock frequency are non-overlapping second aliasing zones corresponding to the second clock frequency except in one overlapping aliasing zone that includes a center frequency of a communications signal in the first RF signal.

16. The method of claim 11, further comprising receiving a resource assignment for communications on a channel of interest, wherein the determining the first clock frequency and the determining the second clock frequency is based on the resource assignment.

17. The method of claim 11, wherein the first clock frequency is a center frequency of a channel of interest, and wherein the second clock frequency is determined as a sum or difference of the first clock frequency with a result of dividing a bandwidth of the channel of interest by an integer corresponding to a Nyquist zone.

18. The method of claim 11, wherein sampling the first RF signal for downconversion comprises sampling a RF signal received from a primary antenna, and wherein sampling the second RF signal for downconversion comprises sampling a RF signal received from a diversity antenna.

19. An apparatus, comprising:
a memory storing processor-readable code; and
at least one processor coupled to the memory, the at least one processor configured to execute the processor-readable code to cause the at least one processor to perform operations including:
determining a first clock frequency for sampling a first radio frequency (RF) signal and a second clock frequency for sampling a second RF signal that is a spatially-diverse representation of the first RF signal,
wherein the first clock frequency is different from the second clock frequency;
sampling the first RF signal for downconversion based on the first clock frequency to a first output signal; and
sampling the second RF signal for downconversion based on the second clock frequency to a second output signal.

20. The apparatus of claim 19, wherein the first output signal comprises a first baseband signal and the second output signal comprises a second baseband signal, the operations further comprising determining information in a channel of interest in the first RF signal based on the first baseband signal and the second baseband signal.

21. The apparatus of claim 19, wherein the second clock frequency is different from the first clock frequency by an offset value proportional to a bandwidth of a communications signal in the first RF signal.

22. The apparatus of claim 21, wherein the first clock frequency corresponds to a center frequency of the communications signal.

23. The apparatus of claim 22, further comprising:
a first RF processing path coupled to the at least one processor, the first RF processing path comprising a first analog-digital converter (ADC) configured to sample the first RF signal based on a first clock signal having the first clock frequency; and
a second RF processing path coupled to the at least one processor, the second RF processing path comprising a second analog-digital converter (ADC) configured to sample the second RF signal based on a second clock signal having the second clock frequency.

24. The apparatus of claim 23, further comprising:
a first antenna port configured to couple the first RF processing path to a primary antenna; and
a second antenna port configured to couple the second RF processing path to a diversity antenna.

25. The apparatus of claim 19, wherein the first clock frequency is a center frequency of a channel of interest, and wherein the second clock frequency is determined as a sum or difference of the first clock frequency with a result of dividing a bandwidth of the channel of interest by an integer corresponding to a Nyquist zone.

26. An apparatus, comprising:
means for determining a first clock frequency for sampling a first radio frequency (RF) signal and a second clock frequency for sampling a second RF signal that is a spatially-diverse representation of the first RF signal, wherein the first clock frequency is different from the second clock frequency;
means for sampling the first RF signal for downconversion based on the first clock frequency to a first output signal; and
means for sampling the second RF signal for downconversion based on the second clock frequency to a second output signal.

27. The apparatus of claim 26, wherein the first output signal comprises a first baseband signal and the second output signal comprises a second baseband signal, the apparatus further comprising means for determining information in a channel of interest in the first RF signal based on the first baseband signal and the second baseband signal.

28. The apparatus of claim 26, wherein the second clock frequency is different from the first clock frequency by an offset value proportional to a bandwidth of a communications signal in the first RF signal.

29. The apparatus of claim 28, wherein the first clock frequency corresponds to a center frequency of the communications signal.

30. The apparatus of claim 26, wherein the first clock frequency and the second clock frequency results in one overlapping aliasing zone that includes a center frequency of a communications signal in the first RF signal.
